(19) United States
(12) Patent Application Publication
(10) Pub. No.: US 2008/0277883 A1
(43) Pub. Date: Nov. 13, 2008

(54) Multilayered gasket for internal combustion engine

(76) Inventors: Corey Hager, Stanford, NY (US); Jim Mikos, Westchester, IL (US); Herb Todd, King's Mountain, KY (US)

Correspondence Address: MARSHALL & MELHORN, LLC, FOUR SEAGATE, 8TH FLOOR, TOLEDO, OH, 43804, US

(21) Appl. No.: 12/151,508

(22) Filed: May 7, 2008

Related U.S. Application Data
(60) Provisional application No. 60/928,582, filed on May 10, 2007.

(51) Int. Cl. F02F 11/00; B23P 11/00

(52) U.S. Cl. 277/598; 29/464

(57) ABSTRACT

A gasket for internal combustions is held together by form-locks that do not extend beyond the outer surfaces of the gasket. The form-locks are established in regions where some of the sheets of the gasket do not extend and thus do not incorporate the thickness of those sheets, yet all of the gasket sheets are securely joined.

### RELATED APPLICATIONS

The present application claims benefit under 35 USC 119(e) from the provisional application filed on May 10, 2007 under 35 USC 119(b), which has been assigned patent application No. 60/928,582, which is incorporated by reference in its entirety.

### FIELD

A gasket such as that used for an internal combustion engine is disclosed with multiple sheets interlocked with each other.

### BACKGROUND

Gaskets are commonly used to act as a seal between mating mechanical components. A first mechanical component may contain one or more ports or channels that are meant to engage with corresponding ports or channels in a second mechanical part to create a single continuous channel. Typically, such channels transport fluids such as combustion gases and contaminants when used in the environment of an internal combustion engine. For proper performance, the avoidance of accidental leakage of fluids from the channels is desired. Thus, a gasket is typically placed between the mating components and is provided with openings corresponding to the channels to be sealed. When compressed between the mating components, the gasket forms a seal adjacent the openings.

FIG. 1 shows a prior art gasket for an internal combustion engine. The gasket 20 is formed with a plurality of apertures 22. These apertures correspond to openings 24 of channels in the engine block; for example, the apertures may correspond to openings for engine cylinder bores, fluid channels, and bolt holes.

As depicted in FIG. 2, the gasket 20 comprises a plurality of sheets such as sheets 26, 28, 30. These sheets are arranged as layers, there being a pair of outer sheets 26, 28 and at least one or more inner sheets 30. Preferably the outer sheets 26, 28 are formed of steel, however one having skill in the art may choose any suitable alternative material. Materials for the inner sheets 30 may be selected to satisfy desired operational characteristics, for example, a thermally insulating material may be the choice.

The apertures 22 comprise aligned openings 32 of the sheets 26, 28, 30 of the gasket 20. To form a satisfactory seal for openings 24 of a mating component, the individual apertures 22 of each sheet collectively forming an opening 32 must be precisely aligned. In turn, each opening 32 is precisely aligned with a corresponding opening 24. Even when aligned, the sheets 26, 28, 30 must be securely joined to maintain this precise alignment.

One specific gasket that is known is a head gasket, which is disposed between an engine block and a cylinder head of an internal combustion engine. Such a gasket is commonly a steel laminate gasket, including at least two sheets each sheet having apertures aligned with the channels to be sealed. To ensure that a proper seal is formed adjacent the gasket apertures, the sheets of the gasket must be precisely aligned and, once so aligned, securely held together. Additionally, fluid must be prevented from flowing into the regions between the laminate sheets of the gasket itself.

One common device used to achieve this purpose is an eyelet or grommet as shown in cross-section in FIG. 3. An eyelet is a separate part applied to the inner periphery of the aperture and has flanges folded against the outer surfaces of the gasket. The eyelet is applied to the openings in the steel sheets to keep the openings held in alignment and prevent fluid from flowing into the regions between the sheets of the gasket. More specifically, FIG. 3 depicts a cross-sectional view of an eyelet 34 as known in the art. This separate piece of material is applied at the inner periphery of one of the apertures 22 to mechanically attach the sheets 26, 28, 30. The eyelet consists of a cylindrical element 34a and a pair of flanges 34b, 34c. The cylindrical element 34a extends through the openings 32, keeping the sheets 26, 28, 30 aligned and preventing any fluid from flowing into the regions between the sheets. The flanges 34b, 34c hold the sheets together in this alignment. However, the process for making gaskets with these additional eyelet components has several shortcomings as noted above: (1) missing eyelets, (2) inconsistent eyelet dimensions, (3) positional tolerance “stack-up” of eyelet holes causing malformed eyelets, (4) eyelet fragment contamination between sheets, (5) improper ordering of sheets, (6) eyelet component cost, and (7) downtime due to maintenance of eyeleting machines.

The process for making gaskets with these additional eyelet components has several shortcomings. For example, gaskets are sometimes produced that lack one or more eyelets due to machine error. Additionally, the dimensions of the eyelets may be inconsistent, causing variances in the performance characteristics of the gasket. Another shortcoming is that “positional tolerance stack-up” can result in a malformed eyelet.

More particularly, as shown in FIG. 4, a minimal amount of alignment error Δ₁ may occur between two adjacent sheets that may be too small to detect or prevent and thus may be within the necessary positional tolerances of manufacturing. However the cumulative effect of these errors between several sheets may “stack up” and cause the openings in the outermost sheets to be misaligned by a substantial amount Δ_{N} causing the resultant eyelets to be misshapen. Further, fragments of eyelet may contaminate the regions between the sheets of the gasket. Yet another shortcoming is that, because corresponding openings in the sheets are identically sized, the sheets to be attached may be improperly ordered when eyeleted. These difficulties may lead to gaskets that are unusable and must be discarded or reworked, thereby incurring additional costs. Further issues include the material and assembly costs associated with the eyelets themselves. Additionally, the machines used to apply the eyelets require periodic maintenance that stalls the manufacturing process.

An alternative technique for holding the sheets of a gasket securely in proper alignment and providing an effective seal is to machine the sheets so that they mechanically interlock with each other, requiring no additional components. An example of this technique is a form-lock as shown in cross-section in FIG. 5. Typically, a first sheet is formed with a flange at the aperture that extends through the second sheet and is folded down against the second sheet. Form-locks can alleviate some of the shortcomings associated with the separate components of eyelets. Additionally, the flange on one of the sheets may serve as a mechanical constraint that prevents or decreases the likelihood of the sheets from being assembled in an improper order (“poka-yoke”). However, this technique is still sensitive to positional tolerance stack-up if several layers are joined by the forn-lock.

More specifically, FIG. 5 depicts a cross-sectional view of a form-lock 40 as another means for securely joining multiple sheets 26,28, 30. One of the outer sheets 28 additionally comprises a flange 42 that extends from the periphery of the opening 32. The flange 42 has a cylindrical portion 42a that extends through the openings 32 in the remaining sheets 26, 30 and a flat portion 42b that is folded back against the outer sheet 26. This form-lock structure 40 securely attaches the sheets 26, 28, 30 through a mechanical interlock without the need for extra components and the surface of the cylindrical portion of the flange 42a provides a sealing surface to prevent fluid from flowing into the regions between the sheets.

Apart from manufacturing concerns, prior art approaches also suffer from operational shortcomings. As known in the art, a final aperture structure protrudes beyond the outer surfaces of the gasket sheets. For example, as shown in FIGS. 3 and 5, eyelets 34 and form-locks 40, protrude beyond the planes 36, 38 defined by the outer surfaces of the gasket. This is undesirable because the gaskets are typically used under high pressures and the protrusion results in uneven application of this pressure. This uneven pressure may cause premature wear on the gasket (e.g., exacerbate stress in a localized region) or potentially create poor sealing conditions.

### BRIEF DESCRIPTION OF THE DRAWINGS

The features and advantages of the present gasket will be apparent from the following description, taken in conjunction with the accompanying drawings, in which

FIG. 1 is a view of a prior art cylinder head gasket and engine block with corresponding openings for cylinder bores and fluid channels;

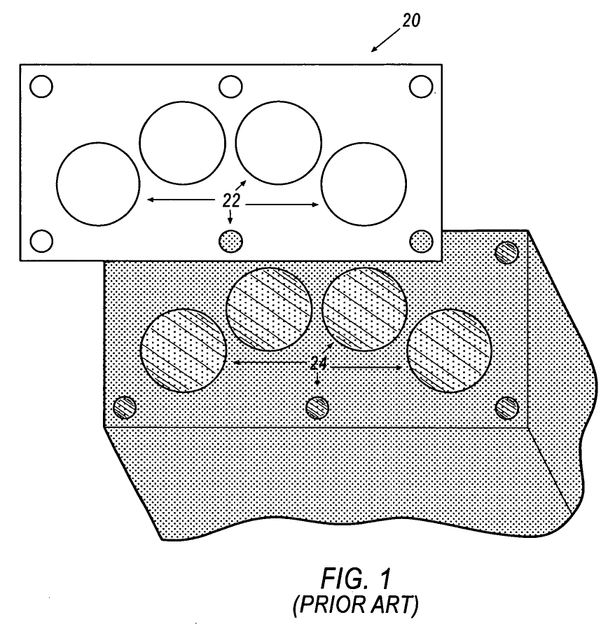

FIG. 2 is an exploded view of a prior art sheet metal gasket depicting a plurality of sheets including two outermost sheets and several inner sheets disposed between the outermost sheets;

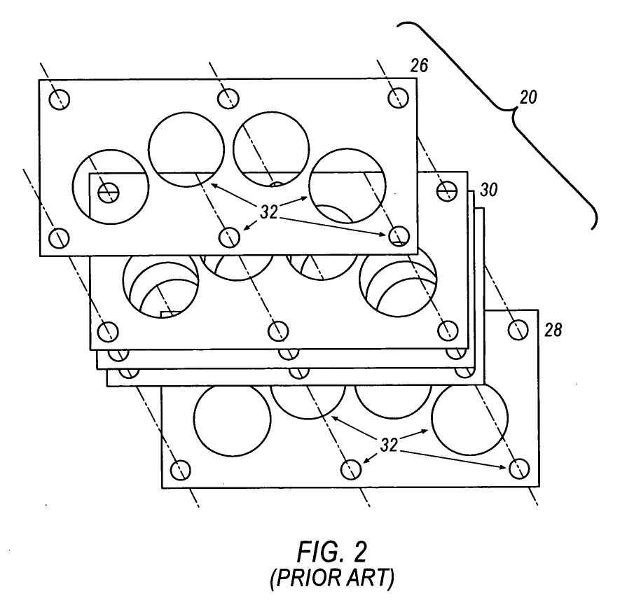

FIG. 3 is a cross-sectional view of a prior art eyelet arrangement for joining the sheets of a gasket at an aperture therein;

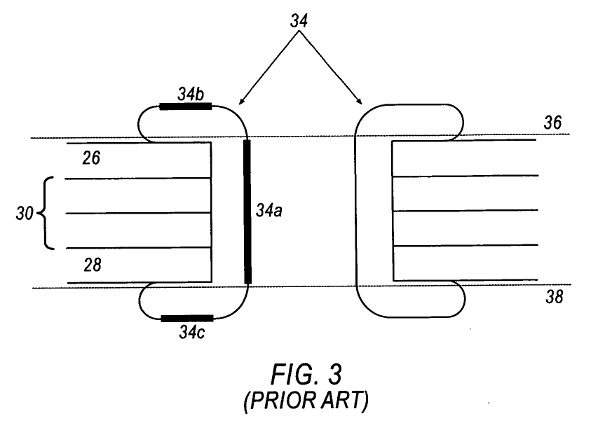

FIG. 4 is a cross-sectional view of a prior art eyelet arrangement for joining the sheets of a gasket at an aperture therein depicting the effects of positional tolerance stack-up;

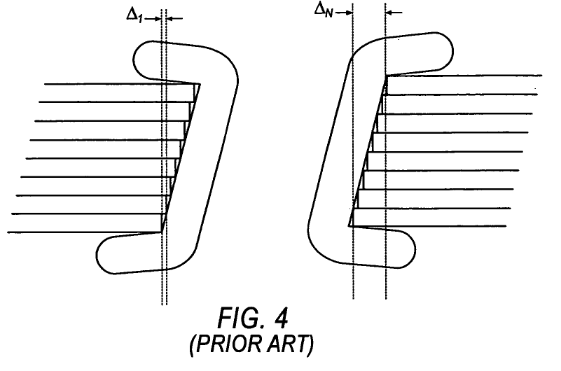

FIG. 5 is a cross-sectional view of a prior art form-lock arrangement for joining the sheets of a gasket at an aperture therein;

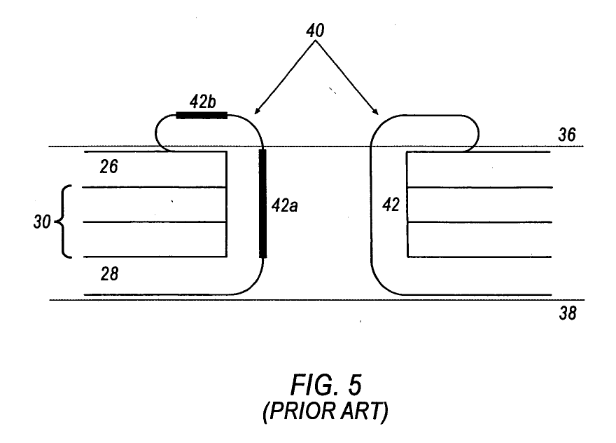

FIG. 6 is a cross-sectional view of an aperture in a gasket according to a first exemplary embodiment;

FIGS. 7A-C comprise a series of three cross-sectional views of an aperture in a gasket according to the first embodiment, showing the procedural steps involved in forming the improved form-lock;

FIGS. 8A-B comprise cross-sectional views of two apertures in a gasket having a form-lock according to a second exemplary embodiment; and

FIG. 9 is a cross-sectional view of an aperture in a gasket having a form-lock according to a third exemplary embodiment.

### DETAILED DESCRIPTION

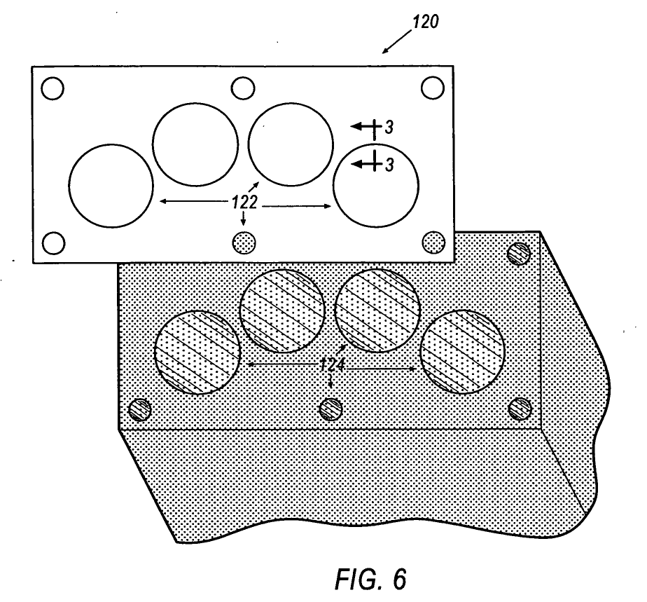

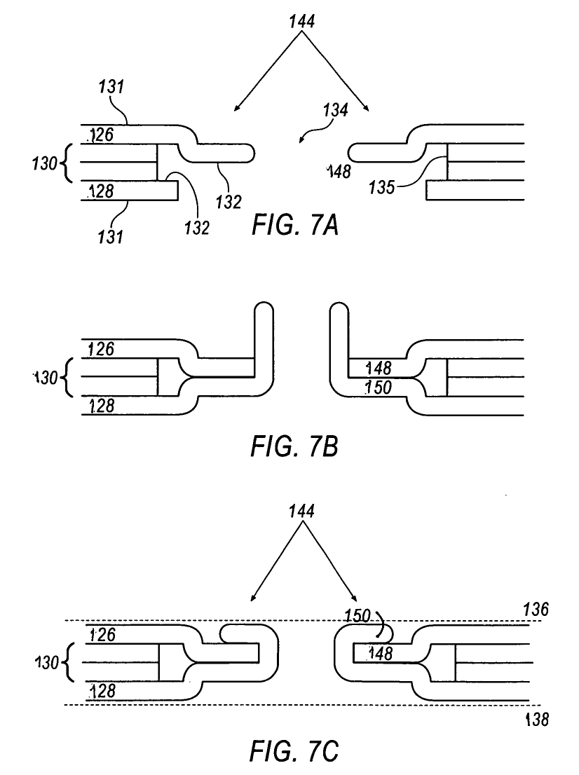

A first example of an improved gasket 120 is illustrated in FIGS. 6 and 7. A metallic form-lock 144 is used to join outer metallic sheets 126, 128 of the gasket 120. Each of sheets 126, 128 include an outer surface 131, an inner surface 132, and at least one opening 134 formed therein. One or more inner sheets are disposed between sheets 126, 128, each inner sheet including at least one opening 135 formed therein in alignment with opening 134. The form-lock 144 is restricted to a region in which the inner sheets 130 do not extend between the outer sheets 126, 128. So long as the combined thickness of inner sheets 130 is at least as thick as outer sheet 128, form-lock 144 will be no thicker than the gasket 120 and can therefore be located so that it does not protrude beyond the planes 136, 138 defined by the outer surfaces of the gasket, being disposed within planes 136, 138.

As shown in FIG. 7, one method of establishing form-lock 144 is to form material from the outer sheets 126, 128. In FIG. 7a, a first extrusion 148, formed by interaction of a male punch and a female die (not shown), extends from the periphery of the opening in the first sheet 126 a sufficient distance so that the flange of the form-lock 144 will not overlap with the inner sheets 130. In FIG. 7b, a second extrusion 150 extends from the periphery of the opening in the second outer sheet 128 beyond the first extrusion 148 and through the aperture 134. As shown in FIG. 7c, the second extrusion 150 is then folded back over the first extrusion 148. The only sheet within the flange of the second extrusion 150 is the extrusion 148 of the first outer sheet 126. The thickness of the form-lock 144 is therefore equal only to the thickness of sheet 126 added to twice the thickness of sheet 128. Therefore in this embodiment, as long as the inner sheets 130 are at least as thick as the outer sheet 128, the resulting form-lock 144 is no thicker than the rest of the gasket 120 and can be confined within the planes 136, 138 defined by the outer surfaces of the gasket. Because form-lock 144 envelops only two sheets, the problems caused by positional tolerance stack-up are attenuated. If the extrusions are achieved before the sheets are placed together they may serve as a fail-safe or mistake proof device to ensure that a proper ordering of the sheets. Because the inner sheets 130 do not experience uneven stresses and are not exposed, they can be formed of a broader range of materials. For example, a non-metallic thermally insulating material can be selected for the inner sheets 130.

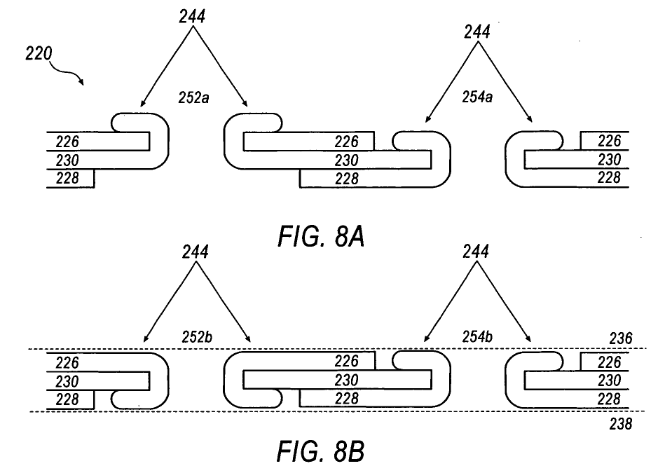

In an alternative embodiment of a gasket 220 shown in cross-section in FIG. 8, at least two form-locks 252, 254 are established in the gasket 220 at different locations. These form locks are formed from formed material as described in connection with the first embodiment and join respectively different pairings of sheets. For example, as shown in FIG. 8a, a first form-lock 252a attaches the outer sheet 226 to the inner sheet 230. This first form-lock formed of material formed from the layers 226, 230 so that it does not overlap with the remaining layers (in this example, outer layer 228) in a similar manner to that shown in FIG. 7. The thickness of the form-lock is therefore only as great as the outer sheet 226 added to twice the thickness of inner sheet 230. A second form-lock 254a similarly attaches the inner sheet 230 with the outer sheet 228. This second form-lock 254a is similarly formed of material formed from the layers 226, 230 so that its thickness is only as great as the inner sheet 230 added to twice the thickness of outer sheet 228. The resultant gasket 220 has three sheets 226, 228, 230 joined with each other while each individual form-lock 252a, 254a respectively joins only two sheets and is no thicker than the gasket 220. Additional sheets can be securely attached to the gasket with similar form-locks without requiring any increase in individual form-lock thickness. This alleviates some of the uneven stresses that would be caused by previously known attachment methods as well as problems associated with positional tolerance stack-up.

As shown in FIG. 8b, the direction of these form-locks 252b, 254b can be adjusted so that the flanges respectively extend from the outer sheets 226, 228 through the inner sheet 230. In this configuration of the second embodiment the form-locks 252b, 254b are confined within the planes 236, 238 defined by the outer surfaces of the gasket 220 so long as the outer sheets 226, 228 are of the same thickness. This configuration further reduces uneven stresses on the apertures of gasket 220.

Because the form-locks 244 of this embodiment envelop a reduced number of sheets, the problems caused by positional tolerance stack-up are attenuated. If the extrusions are achieved before the sheets are placed together they may serve as a fail-safe or a mistake proof device to ensure a proper ordering of the sheets.

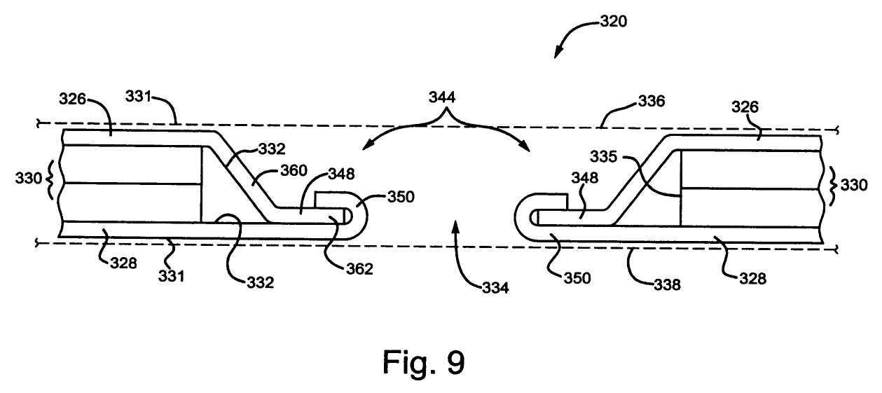

Referring now to FIG. 9, yet another embodiment of a gasket 320 present invention is depicted. In this embodiment, a metallic form-lock 344 is used to join outer metallic sheets 326, 328 of the gasket 320. Each of sheets 326, 328 include an outer surface 331, an inner surface 332, and at least one opening 334 formed therein.

One or more inner sheets 330 are disposed between sheets 326, 328, each inner sheet 330 including at least one opening 335 formed therein in alignment with opening 334. The form-lock 344 is restricted to a region in which the inner sheets 330 do not extend between the outer sheets 326, 328. So long as the combined thickness of inner sheets 330 is at least as thick as outer sheet 328, form-lock 344 will be no thicker than the gasket 320 and can therefore be located so that it does not protrude beyond the planes 336, 338 defined by the outer surfaces of the gasket, being disposed within planes 336, 338.

One method of establishing form-lock 344 is to form material from the outer sheets 326, 328. A first extrusion 348, formed by the interaction of a male punch and a female die (not shown), extends beyond the opening 335 in the inner sheet 330 a sufficient distance so that the form-lock 344 will not overlap with the inner sheet 330.

The first extrusion 348 has a first portion 360 angled toward the outer sheet 328. A second portion 362 of the first extrusion 348 extends substantially parallel to the outer sheet 328. A second extrusion 350, formed in a similar manner to the first extrusion 348, extends beyond the opening 335 in the inner sheet 330. The second extrusion 350 is then folded back over the first extrusion 348.

The only sheet within the second extrusion 350 is the first extrusion 348. The thickness of the form lock 330 is therefore equal only to the thickness of the first outer sheet 326 added to twice the thickness of the sheet 328. Therefore, in this embodiment, as long as the inner sheets 330 are at least as thick as the outer sheet 328, the resulting form-lock 344 is no thicker than the rest of the gasket 320 and can be confined within the planes 336, 338 defined by the outer surfaces of the gasket.

Based on the foregoing, it can be appreciated that if the gasket needs to be disassembled or the form locks need to be re-worked, that only the layers of the form lock may be impacted. Thus, the layers not forming the form lock are preserved in substantially their original state.

It can also be appreciated that any of the form locks disclosed herein can be used on the same gasket with any of the other forms locks disclosed herein to have locking devices that are easier to locate and/or manufacture in particular places in the gasket and/or to employ a particular lock at a particular location on the gasket based on the effectiveness and/or characteristics of the lock.

The preferred embodiments described are exemplary only and not meant to be restrictive beyond the express limitations of the appended claims. Descriptive labels such as “outer sheet” are for illustrative purposes of the exemplary embodiments and are not meant to exclude embodiments consisting of more or fewer sheets than disclosed herein. Modifications or alterations may be made to the disclosed embodiments without departing from the scope of the following claims.

What is claimed is:

1. A gasket for an internal combustion engine, comprising:
first and second metallic sheets each having an outer surface, an inner surface, and at least one opening formed therein,
at least one inner sheet disposed between the inner surfaces of the first and second metal sheets, the inner sheet having at least one opening formed therein,
said openings being aligned to form an aperture in the gasket, and
a form-lock joining two of the sheets at the aperture,
wherein the form-lock is disposed entirely within the planes defined by the outer surfaces of the first and second metal sheets.

2. The gasket of claim 1, wherein the two sheets joined by the form-lock are the first and second metal sheets.

3. The gasket of claim 1, wherein the two sheets joined by the form-lock are the second metal sheet and the inner sheet.

4. The gasket of claim 1, wherein the inner sheet comprises a thermally insulating material.

5. A gasket for an internal combustion engine, comprising:
first and second metal sheets each having an outer surface, an inner surface, and first and second openings formed therein,
at least one inner sheet disposed between the inner surfaces of the first and second metal sheets, the inner sheet having first and second openings formed therein,
said first openings being aligned to form a first aperture in the gasket,
said second openings being aligned to form a second aperture in the gasket,
a first form-lock joining the first metal sheet and the inner sheet at the first aperture, and
a second form-lock joining the second metal sheet and the inner sheet at the second aperture.

6. The gasket of claim 5, wherein at least one of the form-locks is disposed entirely within the planes defined by the outer surfaces of the first and second metal sheets.

7. The gasket of claim 5, wherein both of the form-locks are disposed entirely within the planes defined by the outer surfaces of the first and second metal sheet.

8. The gasket of claim 5, wherein the inner sheet comprises a thermally insulating material.

9. A method of forming a gasket for an internal combustion engine, comprising:
providing first and second metal sheets each having at least one opening formed therein,
providing at least one inner sheet having at least one opening formed therein,
disposing the inner sheet between the first and second metal sheets,
aligning said openings to form an aperture in the gasket, and
joining two of the sheets in a form-lock at the aperture in a manner whereby the form-lock is disposed entirely within planes defined by outer surfaces of the first and second metal sheets.

10. The method of forming a gasket of claim 9, wherein the two sheets joined by the form-lock are the first and second metal sheets.

11. The method of forming a gasket of claim 9, wherein the inner sheet comprises a thermally insulating material.

12. A method of forming a gasket for an internal combustion engine, comprising:
providing first and second metal sheets each having at least first and second openings formed therein,
providing at least one inner sheet having at least first and second openings formed therein,
disposing the inner sheet between the first and second metal sheets,
respectively aligning said openings to form first and second apertures in the gasket,
joining the first metal sheet and the inner sheet at the first aperture, and
joining the inner sheet and the second metal sheet at the second aperture.

13. The method of forming a gasket of claim 12, wherein at least one of the form-locks is disposed entirely within the planes defined by the outer surfaces of the first and second metal sheets.

14. The method of forming a gasket of claim 12, wherein both of the form-locks are disposed entirely within the planes defined by the outer surfaces of the first and second metal sheets.

15. A gasket for an internal combustion engine, comprising:
at least three sheets arranged in a laminate fashion,
a plurality of apertures formed of aligned openings in the sheets, and
a plurality of form-locks joining said sheets at the apertures,
each of said form-locks joining fewer than all the sheets,
said form-locks being so distributed that each of the sheets is joined by at least one of said form-locks to each adjacent one of the sheets.

16. The gasket of claim 15, wherein the form-locks are disposed entirely within the planes defined by the outer surfaces of the gasket.

17. The gasket of claim 15, wherein any one of said form-locks joins exactly two sheets.
